(19) United States
(12) Patent Application Publication
(10) Pub. No.: US 2007/0075984 A1
(43) Pub. Date: Apr. 5, 2007

(54) Method and device for scroll bar control on a touchpad having programmed sections

(76) Inventors: Yen-Chang Chiu, Linkou Township (TW); Tso-Chieh Yang, Chingshuei Townsh (TW); Chen-Yao Yang, Chingshuei Townsh (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/529,227

(22) Filed: Sep. 29, 2006

(30) Foreign Application Priority Data
Oct. 4, 2005 (TW) 094134724

(51) Int. Cl. G09G 5/00

(52) U.S. Cl. 345/173

(57) ABSTRACT

A scrolling region is selected on a touchpad and defined several sections each of which corresponding to a displacement signal in a specific direction, such that by touching on the programmed sections to trigger the respective displacement signals, a scroll bar on a window becomes more easily to control for scrolling in desired direction with desired displacement.

### FIELD OF THE INVENTION

The present invention is related generally to a method and device for scroll bar control and, more particularly, to a method and device for scroll bar control on a touchpad.

### BACKGROUND OF THE INVENTION

Due to the compactness, low cost, low power consumption and long lifetime, touchpad has been widely used in various electronic products such as notebook computer, mouse, MP3 player, and mobile phone, etc., as an input device. For operating with a touchpad, user needs only to use his finger or conductor such as touch pen to touch or slide on a panel of the touchpad to move a cursor on a window in a relative displacement or an absolute coordinate variation, in order to perform various functions such as text writing and scroll bar scrolling. For the scroll bar control, as shown in FIG. 1, a touchpad 100 is programmed with several regions, in which region 110 is for cursor operation, region 120 is for vertical scroll bar, and region 130 is for horizontal scroll bar. For moving a cursor on a window, it is to put a finger on the cursor operation region 110 and operate the cursor on the window by the action of the finger, for scrolling a vertical scroll bar on a window, it is to put a finger on the vertical scrolling region 120 and operate the scroll bar on the window according to the vertical displacement of the finger, and for scrolling a horizontal scroll bar on a window, it is to put a finger on the horizontal scrolling region 130 and operate the scroll bar on the window according to the horizontal displacement of the finger. However, it is difficult to scroll the scroll bar on a window quickly and precisely by a finger sliding on a smooth touchpad, and the finger must move piece by piece for scrolling the window to the target range, thereby causing inconvenience of use and operation.

Therefore, it is desired a method for scroll bar control on a touchpad more easily for users to operate therewith.

### SUMMARY OF THE INVENTION

An object of the present invention is to provide a method and device for scroll bar control on a touchpad having multiple section control.

According to the present invention, a scrolling region is selected on a touchpad and several sections are programmed thereof, in which each of the programmed sections is defined with a certain displacement in a specific direction. By touching on the programmed sections to trigger the respective displacement signals, a scroll bar on a window becomes more easily to control for scrolling in desired direction with desired displacement.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a conventional touchpad having scroll bar control function;

FIG. 2 shows a device having scroll bar control function according to the present invention;

FIGS. 3A-3E show further details in the scroll bar control operation according to the present invention; and

FIGS. 4A-5B show another embodiment according to the present invention.

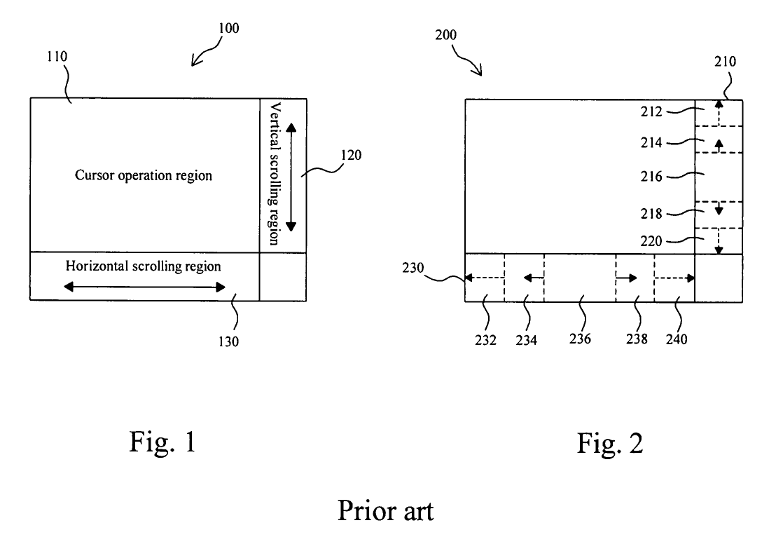

### DETAILED DESCRIPTION OF THE INVENTION

FIG. 2 shows a device according to the present invention, in which a touchpad 200 is programmed with a vertical scrolling region 210 and a horizontal scrolling region 230. The vertical scrolling region 210 is programmed with several sections 212, 214, 216, 218, and 220, each of which is defined with a certain displacement for a vertically scroll signal. For example, the section 216 is the one without displacement, the section 214 is for scrolling upward with less displacement, the section 212 is for scrolling upward with greater displacement, the section 218 is for scrolling downward with less displacement, and the section 220 is for scrolling downward with greater displacement. By touching on the sections 212 to 220, a vertical scroll bar on a window will standstill or vertically scroll with various displacements, depending on which section of them is touched. Similarly, the horizontal scrolling region 230 is programmed with several sections 232, 234, 236, 238, and 240 for scrolling the horizontal scroll bar, in which the section 236 is the one without displacement, the section 232 is for scrolling leftward with greater displacement, the section 234 is for scrolling leftward with less displacement, the section 238 is for scrolling rightward with less displacement, and the section 240 is for scrolling rightward with greater displacement. By touching on the sections 232 to 240, a horizontal scroll bar on a window will standstill or horizontally scroll with various displacement, depending on which section of them is touched. When a user desires to scroll a window more quickly or the current region of the window is far away from the target region, the section corresponding to greater displacement is touched. If the user desires to move in the window precisely, he could touch on the section corresponding to less displacement.

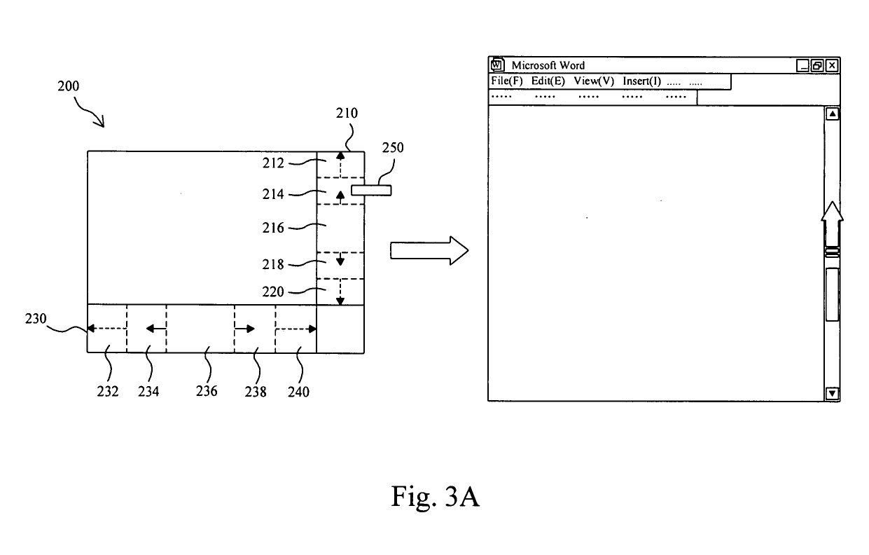

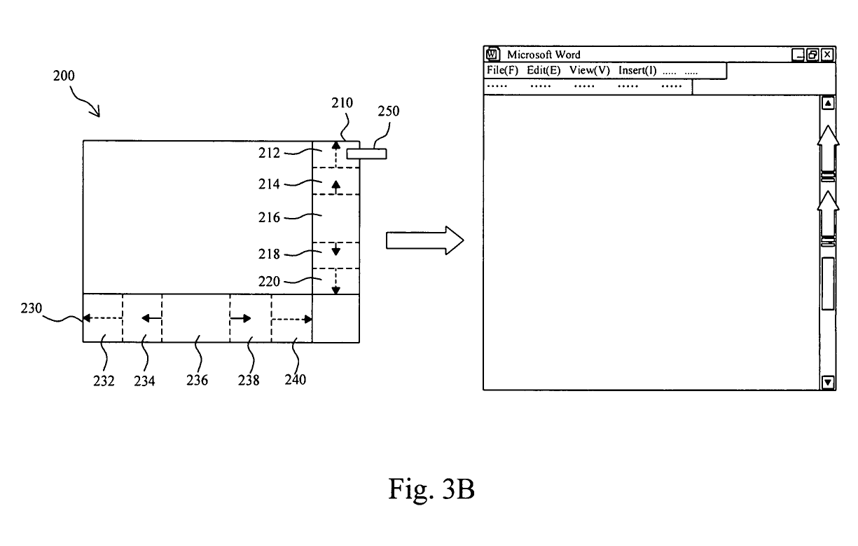

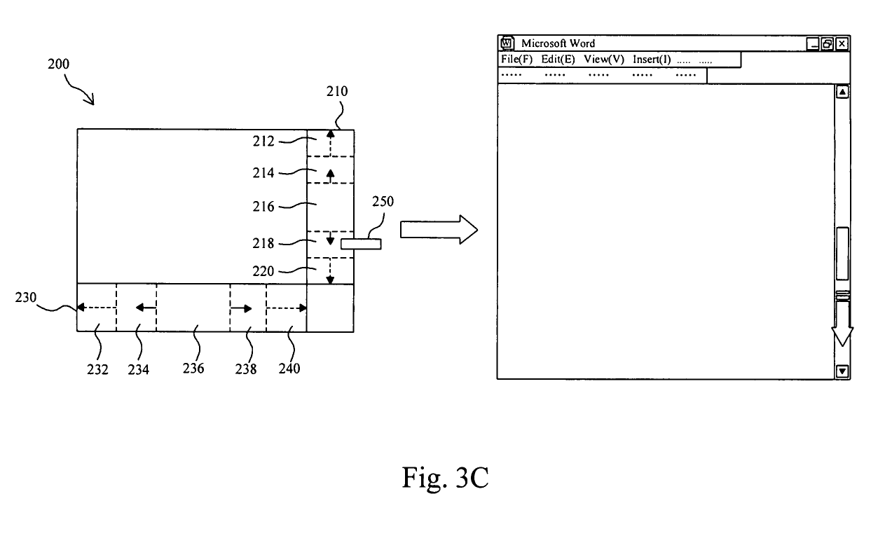

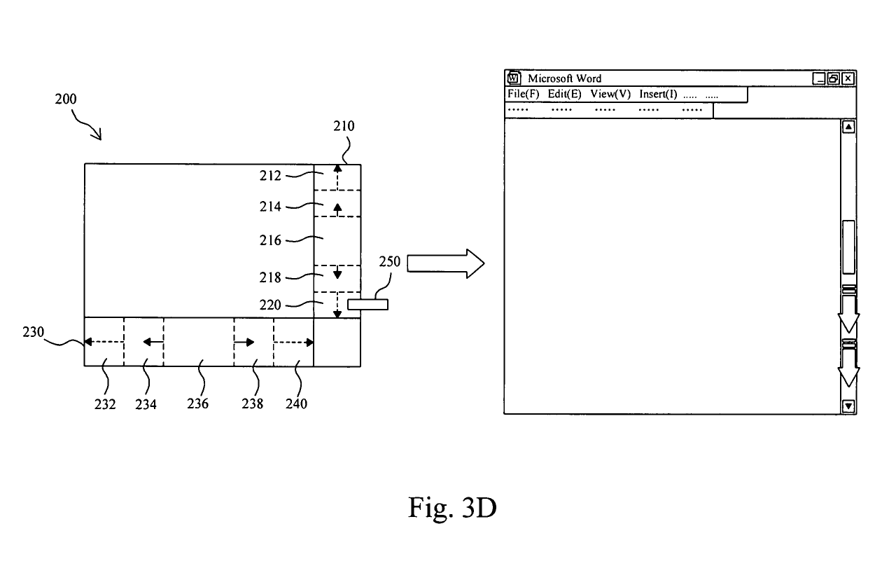

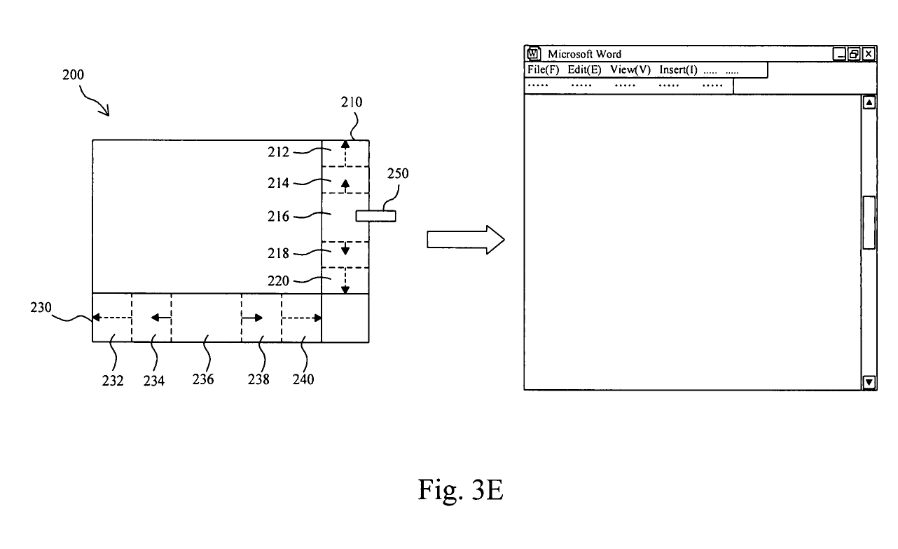

For further details, FIGS. 3A-3E show the operation with the touchpad 200. As shown in FIG. 3A, when an object 250, for example a finger or a conductive object such as a touch control pen, touches on the section 214 of the vertical scrolling region 210, the touchpad 200 will produce a respective upward displacement signal to a host in a predetermined time, so that the vertical scroll bar on a window will scroll upward with the corresponding displacement. In FIG. 3B, it is the section 212 touched by the object 250, and therefore the touchpad 200 produces the upward displacement signal that has been defined for the section 212 to the host to scroll the vertical scroll bar upward. However, the defined displacement for the section 212 is greater than the section 212, and therefore, as shown in FIG. 3B, the window will be scrolled upward with greater amount. If the object 250 touches on the section 218 which is defined with a less displacement in downward direction, as shown in FIG. 3C, the touchpad 200 will produce a downward displacement signal to the host and thereby scroll the window downward with a corresponding displacement. In FIG. 3D, when the object 250 touches on the section 220, the touchpad 200 produces the respective downward displacement signal to the host, so as to scroll the vertical scroll bar on the window downward with greater displacement. As shown in FIG. 3E, when the object 250 leaves the vertical scrolling region 210 or touches on the section 216, the touchpad 200 will not produce any displacement signal, and the scroll bar on the window will not scroll. Hence, a user doesn't need to slide his finger on the scrolling region 210 repeatedly or to do any gesture when he desires to control the scroll bar control on a window. Further, the object 250 moving within a section of the vertical scrolling region 210 will not change the triggering of the displacement signal, which makes the user to operate more easily.

Similarly, when the object 250 operates on the horizontal scrolling region 230 and touches on the section 232, 234, 238, or 240, the touchpad 200 will produce the respective displacement signal which represents a specific leftward or rightward displacement to the host, so that the horizontal scroll bar on the window will scroll leftward or rightward accordingly. When the object 250 leaves the horizontal scrolling region 230 or touches on the section 236, the touchpad 200 will not produce any displacement signal, so that the horizontal scroll bar on the window will not scroll.

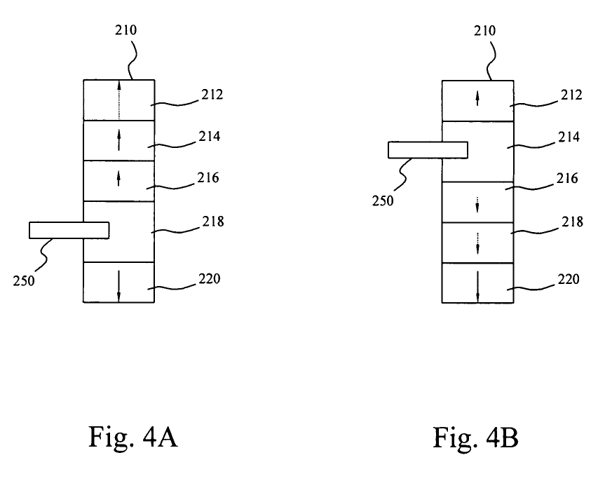

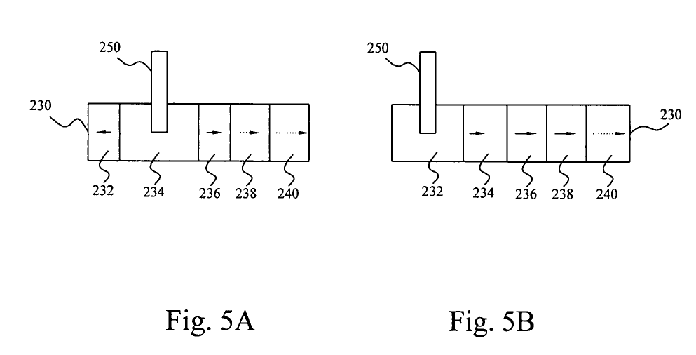

The section corresponding to no displacement signal can be reset according to the requirement of actual use. FIGS. 4A-4B show how to set a section corresponding to no displacement signal on the vertical scrolling region 210, and FIGS. 5A-B show how to set a section corresponding to no displacement signal on the horizontal scrolling region 230. As shown in FIG. 4A, an object 250 falls on the section 218 of the vertical scrolling region 210, and this section 218 is so set to be a section corresponding to no displacement signal. After the setting to the section 218, the other displacement signals are determined for the sections 212, 214, 216, and 220, preferably with the section 218 as a reference. For example, the sections 212, 214, and 216 are assigned corresponding to three upward displacement signals with different displacement amount respectively, and the section 220 is assigned corresponding to a downward displacement signal. If the window is desired to be scrolled downward more quickly, as shown in FIG. 4B, the user can lift the object 250 to leave the vertical scrolling region 210 and then put it down again on the section 214 to reset the section 214 as the one corresponding to no displacement signal. Then, the other sections 212, 216, 218, and 220 are re-assigned with different displacement signal. For example, the section 212 is defined with an upward displacement signal, and the sections 216, 218, and 220 are defined with three downward displacement signals having different displacement amount respectively. By this way, the user can scroll the window downward to the target range more quickly. It therefore increases the flexibility in operation. Referring to FIG. 5A, similarly, the section 234 of the horizontal scrolling region 230 touched by the object 250 first is set to be a section corresponding to no displacement signal, and thereafter, the other sections 232, 236, 238, and 240 are assigned with a leftward displacement signal and three rightward displacement signals respectively. For example, the section 232 is defined with a less displacement leftward, and the section 240 is defined corresponding to the greatest rightward displacement. Once the object 250 lifts and re-falls down to the section 232, it is reset to be a section corresponding to no displacement signal, and the other sections 234, 236, 238, and 240 all become corresponding to rightward displacement but with different displacement amount. Then, the window can be scrolled rightward more quickly than that shown in FIG. 5A.

As shown in the above embodiments, a user doesn't need to slide his finger on the scrolling region repeatedly or to do any gesture for scroll bar control, so that the operation is improved. In addition, it can reset the section corresponding to no displacement signal depending on the actual requirement when operating a touchpad, thereby increasing the flexibility in operation. Furthermore, an object moving within a same section will not change the triggered displacement signal, which makes the user to operate more easily.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set fourth in the appended claims.

What is claimed is:

1. A method for scroll bar control on a touchpad, comprising the steps of:
selecting a scrolling region on the touchpad;
defining a plurality of sections in the scrolling region, each of the sections corresponding to a displacement signal in a specific direction; and
generating a control signal for scroll bar control on a window in response to which one of the sections being touched by an object.

2. The method of claim 1, wherein the specific direction comprises a horizontal direction.

3. The method of claim 1, wherein the specific direction comprises a vertical direction.

4. The method of claim 1, wherein the sections comprise one corresponding to a no displacement signal.

5. The method of claim 4, wherein the section corresponding to a no displacement signal is the one which the object falls down to.

6. The method of claim 4, further comprising the step of assigning the other sections with specific displacement signals according to the section corresponding to a no displacement signal.

7. A device for scroll bar control on a window, comprising:
a touchpad; and
a scrolling region on the touchpad, having a plurality of sections each corresponding to a displacement signal in a specific direction.

8. The method of claim 7, wherein the specific direction comprises a horizontal direction.

9. The method of claim 7, wherein the specific direction comprises a vertical direction.

10. The method of claim 7, wherein the sections comprise one corresponding to a no displacement signal.
